(19) United States
(12) Patent Application Publication
(10) Pub. No.: US 2024/0136856 A1
(43) Pub. Date: Apr. 25, 2024

(54) WIRELESS CHARGING AND NEAR-FIELD COMMUNICATION (NFC) INTEGRATION

(71) Applicant: University of Florida Research Foundation, Incorporated, Gainesville, FL (US)

(72) Inventors: Shuo Wang, Gainesville, FL (US); Zhedong Ma, Gainesville, FL (US); Qinghui Huang, Gainesville, FL (US)

(21) Appl. No.: 18/484,830

(22) Filed: Oct. 11, 2023

Related U.S. Application Data
(60) Provisional application No. 63/415,743, filed on Oct. 13, 2022.

(51) Int. Cl. H02J 50/00; H02J 50/12; H04B 5/00

(52) U.S. Cl. CPC H02J 50/005; H02J 50/12; H04B 5/0037; H04B 5/0081

(57) ABSTRACT

A device for multiplexing a wireless charging (WLC) coil for near-field communication (NFC) is provided. The device includes: the WLC coil with a first end, a second end, and a first contact point located between the first end and the second end; a first terminal connected with the first end of the WLC coil; a second terminal connected with the second end of the WLC coil; and a third terminal connected with the first contact point of the WLC coil, where the first terminal of the WLC coil is configured to be a first WLC terminal; the third terminal of the WLC coil is configured to be a first NFC terminal; and the second terminal of the WLC coil is configured to be multiplexed as a second WLC terminal and a second NFC terminal.

### CROSS-REFERENCE TO RELATED APPLICATIONS

The present application is a continuation of U.S. Provisional Application Ser. No. 63/415,743, titled “WIRELESS CHARGING AND NEAR-FIELD COMMUNICATION (NFC) INTEGRATION,” filed Oct. 13, 2022, the contents of which are incorporated herein by reference in their entirety.

### TECHNICAL FIELD

The present application relates generally to wireless charging (WLC) and near-field communication (NFC) and, in particular, to the integration of wireless charging (WLC) and near-field communication (NFC).

### BACKGROUND

Wireless charging (WLC) coils are deployed in portable electronic products, implantable medical devices, and automobile applications for wirelessly battery charging. Near-field communication (NFC) antennas are also deployed in portable electronic products, implantable medical devices, and automobile applications for data and/or information exchange. The continuous growth of demand for consumer electronic products, implantable medical devices, and electric vehicles significantly increases the demand for WLC coils and NFC antennas.

### BRIEF SUMMARY

Various embodiments described herein relate to methods and systems for the integration of wireless charging (WLC) and near-field communication (NFC).

In accordance with various embodiments of the present disclosure, a device for multiplexing a wireless charging (WLC) coil for near-field communication (NFC) is provided. The device for multiplexing a wireless charging (WLC) coil for near-field communication (NFC) includes: the WLC coil with a first end, a second end, and a first contact point located between the first end and the second end; a first terminal connected with the first end of the WLC coil; a second terminal connected with the second end of the WLC coil; and a third terminal connected with the first contact point of the WLC coil, where: the first terminal of the WLC coil is configured to be a first WLC terminal; the third terminal of the WLC coil is configured to be a first NFC terminal; and the second terminal of the WLC coil is configured to be multiplexed as a second WLC terminal and a second NFC terminal.

In some embodiments, the first WLC terminal and the second WLC terminal are connected to a battery to charge the battery wirelessly.

In some embodiments, the first NFC terminal and the second NFC terminal are connected to an NFC IC for the NFC IC to communicate through NFC with a target device.

In some embodiments, a number of turns of the WLC coil is in a range of 10-14, an inductance value of the WLC coil is in a range of 8-14 μH, and a wireless charging frequency for the WLC coil is approximately 150 kHz.

In some embodiments, an NFC antenna is formed between the first NFC terminal and the second NFC terminal.

In some embodiments, a position of the first contact point depends on an inductance value of the NFC antenna.

In some embodiments, a number of turns of the NFC antenna is in a range of 1-4 turns, an inductance value of the NFC antenna is in a range of 0.2-4.0 μH, and a communication frequency for the NFC antenna is approximately 13.56 MHz.

In some embodiments, the WLC coil is formed in a circular shape or an oval shape.

In accordance with various embodiments of the present disclosure, a device for multiplexing a wireless charging (WLC) coil for near-field communication (NFC) is provided. The device for multiplexing a wireless charging (WLC) coil for near-field communication (NFC) includes: the WLC coil with a first end, a second end, a first contact point located between the first end and the second end, and a second contact point located between the first end and the second end; a first terminal connected with the first end of the WLC coil; a second terminal connected with the second end of the WLC coil; a capacitor having a first plate of the capacitor connected with the first contact point of the WLC coil and a second plate of the capacitor connected with the second contact point of the WLC coil, where: the first terminal of the WLC coil is configured to be multiplexed as a first WLC terminal and a first NFC terminal; and the second terminal of the WLC coil is configured to be multiplexed as a second WLC terminal and a second NFC terminal.

In some embodiments, the first WLC terminal and the second WLC terminal are connected to a battery to charge the battery wirelessly.

In some embodiments, the first NFC terminal and the second NFC terminal are connected to an NFC IC for the NFC IC to communicate through NFC with a target device.

In some embodiments, a capacitance value of the capacitor is in a range of 2-9 nF.

### BRIEF DESCRIPTION OF THE DRAWINGS

The accompanying drawings, which constitute a part of the description, illustrate embodiments of the present invention and, together with the description thereof, serve to explain the principles of the present invention.

FIG. 1 provides an example circuit structure diagram for integrating a wireless charging (WLC) coil and a near-field communication (NFC) antenna, according to some embodiments of the present disclosure.

FIG. 2 provides an example circuit structure diagram for integrating a wireless charging (WLC) coil and a near-field communication (NFC) antenna, according to some embodiments of the present disclosure.

FIG. 3 provides an example circuit diagram for a wireless charging (WLC) coil separate from a near-field communication (NFC) antenna.

FIGS. 4A and 4B provide equivalent circuit diagrams of FIG. 1 for impedance between example terminals, according to some embodiments of the present disclosure.

FIG. 5 provides example curves of measured impedance for an entire WLC coil and its outermost n turns, according to some embodiments of the present disclosure.

FIG. 6 provides an equivalent circuit diagram for impedance of the outermost n turns of a WLC coil in NFC operation mode at 13.56 MHz considering WLC load effect, according to some embodiments of the present disclosure.

FIGS. 7A, 7B, 7C, and 7D provide equivalent circuit diagrams for a second inductive and capacitive region, according to some embodiments of the present disclosure.

FIG. 8 provides an equivalent circuit diagram for impedance of a WLC coil in WLC operation mode considering NFC IC load effect, according to some embodiments of the present disclosure.

FIG. 9 provides example curves of simulated impedance with and without WLC load effect, according to some embodiments of the present disclosure.

FIG. 10 provides example curves of simulated impedance with and without NFC IC load effect, according to some embodiments of the present disclosure.

FIG. 11A provides an example simulation setup for verification in circuit level for the current distribution in winding turns, according to some embodiments of the present disclosure.

FIG. 11B provides example curves of current distribution in different working frequencies in circuit level for current distribution in winding turns, according to some embodiments of the present disclosure.

FIG. 12 provides example curves of measured impedance with and without WLC load effect, according to some embodiments of the present disclosure.

FIG. 13 provides example curves of measured impedance with and without NFC IC load effect, according to some embodiments of the present disclosure.

FIG. 14 provides example curves of measured impedance for NFC antennas, according to some embodiments of the present disclosure.

FIG. 15 provides example diagrams for simulation verification for bandwidth expansion, according to some embodiments of the present disclosure.

FIG. 16 provides example diagrams for experimental verification for bandwidth expansion, according to some embodiments of the present disclosure.

FIG. 17 provides an example circuit structure diagram for integrating a wireless charging (WLC) coil and a near-field communication (NFC) antenna, according to some embodiments of the present disclosure.

FIG. 18 provides an example circuit structure diagram for integrating a wireless charging (WLC) coil and a near-field communication (NFC) antenna, according to some embodiments of the present disclosure.

FIG. 19A provides an example simulation setup diagram for integrating a wireless charging (WLC) coil and a near-field communication (NFC) antenna, according to some embodiments of the present disclosure.

FIG. 19B provides an example simulation setup diagram for integrating a wireless charging (WLC) coil and a near-field communication (NFC) antenna, according to some embodiments of the present disclosure.

FIG. 20 provides simulated impedance curves of WLC coils detected at an NFC port, according to some embodiments of the present disclosure.

FIG. 21 provides example curves of current distribution of each turn of an NFC antenna, according to some embodiments of the present disclosure.

FIG. 22A provides an example diagram of current distribution of an NFC antenna, according to some embodiments of the present disclosure.

FIG. 22B provides an example diagram of current distribution of an NFC antenna, according to some embodiments of the present disclosure.

FIG. 23A provides an example equivalent circuit diagram for integrating a WLC coil and an NFC antenna at a first NFC working frequency, according to some embodiments of the present disclosure.

FIG. 23B provides an example equivalent circuit diagram for integrating a WLC coil and an NFC antenna at a second NFC working frequency, according to some embodiments of the present disclosure.

FIG. 23C provides an example equivalent circuit diagram for integrating a WLC coil and an NFC antenna at a third NFC working frequency, according to some embodiments of the present disclosure.

FIG. 24A provides an example diagram of H-field vector distribution of an NFC antenna using the outermost two turns, according to some embodiments of the present disclosure.

FIG. 24B provides an example diagram of H-field vector distribution of an NFC antenna using the innermost three turns, according to some embodiments of the present disclosure.

FIG. 25A provides an example diagram of H-field magnitude distribution of an NFC antenna using the outermost two turns, according to some embodiments of the present disclosure.

FIG. 25B provides an example diagram of H-field magnitude distribution of an NFC antenna using the innermost three turns, according to some embodiments of the present disclosure.

FIG. 26 provides an example diagram of an experimental setup, according to some embodiments of the present disclosure.

FIG. 27A provides example waveforms with and without the NFC circuit using the outermost two turns, according to some embodiments of the present disclosure.

FIG. 27B provides example waveforms with and without the NFC circuit using the innermost three turns, according to some embodiments of the present disclosure.

FIG. 28A provides example waveforms during a transmitting data phase, according to some embodiments of the present disclosure.

FIG. 28B provides example waveforms during a data receiving phase, according to some embodiments of the present disclosure.

FIG. 29 provides example information received from a card, according to some embodiments of the present disclosure.

### DETAILED DESCRIPTION

The present disclosure more fully describes various embodiments with reference to the accompanying drawings. It should be understood that some, but not all, embodiments are shown and described herein. Indeed, the embodiments may take many different forms, and accordingly, this disclosure should not be construed as limited to the embodiments set forth herein. Rather, these embodiments are provided so that this disclosure will satisfy applicable legal requirements. Like numbers refer to like elements throughout.

Embodiments herein relate to integration of a wireless charging (WLC) coil and a near-field communication (NFC) antenna. High-frequency impedance characteristics of wireless charging coils deployed in cellphones are quantified herein. In some embodiments, integration of a WLC coil and an NFC antenna utilizes a second inductive region of the WLC coil for the NFC antenna. In other embodiments, integration of a WLC coil and an NFC antenna includes applying a frequency selection capacitor to select a portion of the WLC coil to operate as the NFC antenna. Both the WLC load effect and NFC IC load effect are considered and analyzed herein. Embodiments herein further expand the bandwidth of the second inductive region.

Wireless charging (WLC) coils are widely deployed in portable electronic products, implantable medical devices, and automobile applications for wirelessly battery charging. Near-field communication (NFC) antennas are also deployed in many portable electronic products, implantable medical devices, and automobile applications for data and/or information exchange. In 2019, the global consumer electronic market size was USD 729.11 billion, and the market is projected to grow to USD 989.37 billion by 2027. In 2020, the global implantable medical devices market was valued at $91,868.94 million, and is projected to reach $179,032.75 million by 2030, growing at a CAGR of 7.2% from 2021 to 2030. The sale volume of electric vehicles is expected to triple by 2025. This continuous increase in demand for consumer electronic products, implantable medical devices, and electric vehicles significantly increases the demand for WLC coils and NFC antennas. Thus, the integration of WLC coils and NFC antennae can present significant benefits to industrial companies and manufacturers to reduce cost, volume, and weight of products.

A WLC coil typically has 10-14 turns (in some examples, a number of turns may be other than 10-14) to meet inductance value requirements (e.g., 8-14 μH) for wireless charging based on the Qi standard in cellphones (e.g., usually operate around 150 kHz). An NFC antenna typically only needs 1-4 turns (in some examples, a number of turns may be other than 1-4, e.g., an inductance value 0.2-4.0 μH) to ensure its resonant frequency is much larger than its working frequency (e.g., 13.56 MHz).

Different design requirements between NFC antennas and WLC coils present challenges for integrating them together. For example, high-frequency parasitic parameters may make it difficult to integrate a WLC coil and an NFC antenna.

In theory, a frequency selection capacitor may be applied to select part of the WLC coil to function as an NFC antenna at a desired frequency. However, this technique is not applicable in practice at 13.56 MHz. The equivalent parasitic capacitor (EPC) of the WLC coil increases and the first resonant frequency of the WLC coils decrease when the number of winding turns increases. In other words, when functioning at 13.56 MHz, the WLC coils may be dominated by the EPC rather than the inductor.

### Example Embodiments

Embodiments herein overcome the aforementioned shortcomings and more by presenting integrations of WLC and NFC antennas. The high-frequency impedance of wireless charging coils is investigated, characterized, and experimentally verified. The techniques presented herein to integrate the WLC coil and the NFC antenna together meet both the Qi standard and NFC specifications.

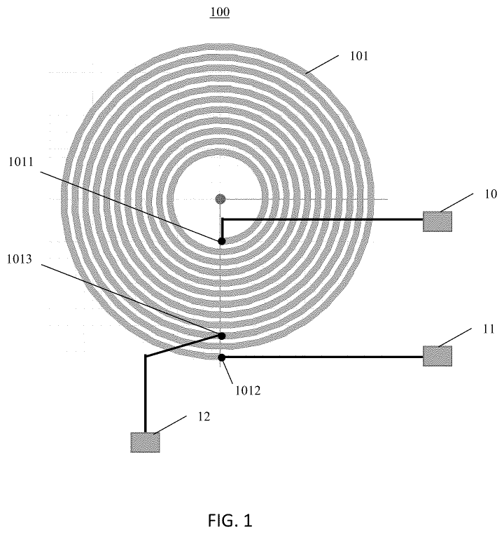

FIG. 1 provides an example circuit structure diagram for integrating a wireless charging (WLC) coil and a near-field communication (NFC) antenna, according to some embodiments of the present disclosure. It will be appreciated that, while contact point 1013 is depicted in a particular location on WLC coil 101 in FIG. 1, the location of the contact point 1013 on the WLC coil 101 may be flexible and may depend on the inductance value needed for the NFC antenna.

As shown in FIG. 1, an example circuit 100 includes a WLC coil 101, a first terminal 10, a second terminal 11, and a third terminal 12. The WLC coil 101 has a first end 1011, a second end 1012, and a first contact point 1013 located between the first end 1011 and the second end 1012. In some examples, the WLC coil 101 may be formed in a circular shape or an oval shape. The first terminal 10 is electrically connected with the first end 1011 of the WLC coil 101. The second terminal 11 is electrically connected with the second end 1012 of the WLC coil 101. The third terminal is electrically connected with the first contact point 1013 of the WLC coil 101.

In some embodiments, the first terminal 10 of the WLC coil 101 is configured to be a first WLC terminal, the third terminal 12 of the WLC coil 101 is configured to be an NFC terminal, and the second terminal 11 of the WLC coil 101 is configured to be multiplexed as a second WLC terminal and a second NFC terminal. Multiplexing the second terminal 11 of the WLC coil 101 enables the use of the second terminal 11 to function as either a second WLC terminal or a second NFC terminal.

An inductive region located between the second end 1012 of the WLC coil 101 and the first contact point 1013 of the WLC coil 101 is configured to be used for the NFC antenna operation. In particular, a portion of the WLC coil 101 between the second terminal 11 and the third terminal 12 are electrically connected in parallel with a remaining portion of WLC coil 101 between the first terminal 10 and the third terminal 12. The portion of the WLC coil 101 between the second terminal 11 and the third terminal 12 in parallel with the remaining portion between the first terminal 10 and third terminal 12 is configured to function as an NFC antenna. For example, the second terminal 11 and the third terminal 12 may be connected to an NFC IC, such that the NFC antenna may help the NFC IC to communicate with a target device.

In some embodiments, the first terminal 10 of the WLC coil 101 and the second terminal 11 of the WLC coil 101 are used for wireless charging. For example, the first terminal 10 and the second terminal 11 may be connected to a battery, such that the WLC coil may help charge the battery wirelessly.

In some embodiments, all of the turns of the WLC coil 101 are configured to be used for wireless charging. In some embodiments, a portion of the turns of the WLC coil 101 are configured to be used for wireless charging. For example, the first terminal 10 may be electrically connected with a second contact point located between the first end 1011 and the first contact point 1013 of the WLC coil 101. Alternatively, the second terminal 11 may be electrically connected with a third contact point located between the second end 1012 and the first contact point 1013 of the WLC coil 101.

In some embodiments, the WLC coil 101 has 10-14 turns with an inductance value in a range of 8-14 μH. The wireless charging frequency for the WLC coil 101 is approximately 150 kHz.

In some embodiments, the NFC antenna has 1-4 turns with an inductance value in a range of 0.2-4.0 μH. The communication frequency for the NFC is approximately 13.56 MHz. In some embodiments, a number of turns of the NFC antenna is flexible, which depends on requirements of the NFC antenna.

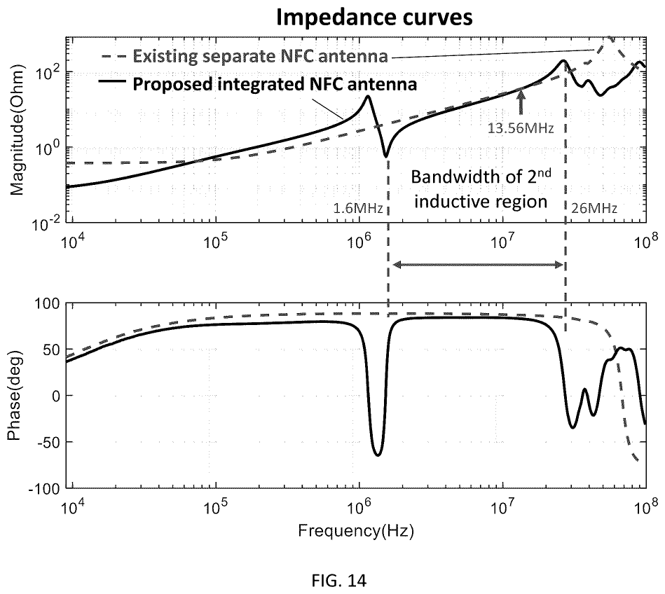

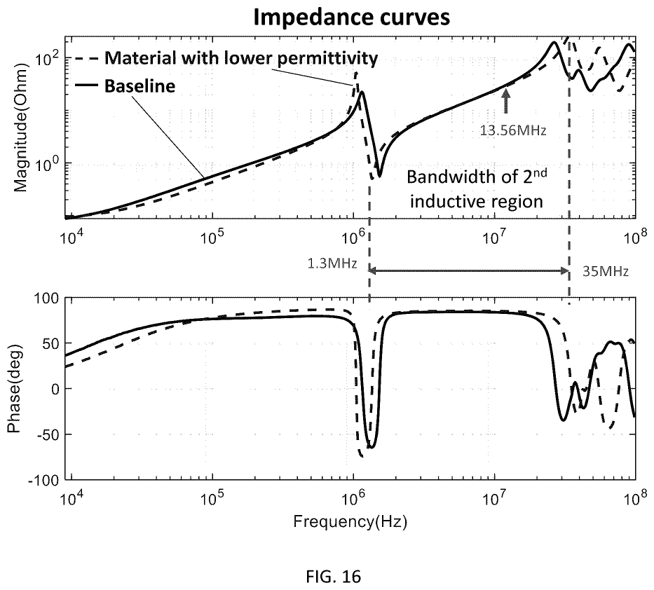

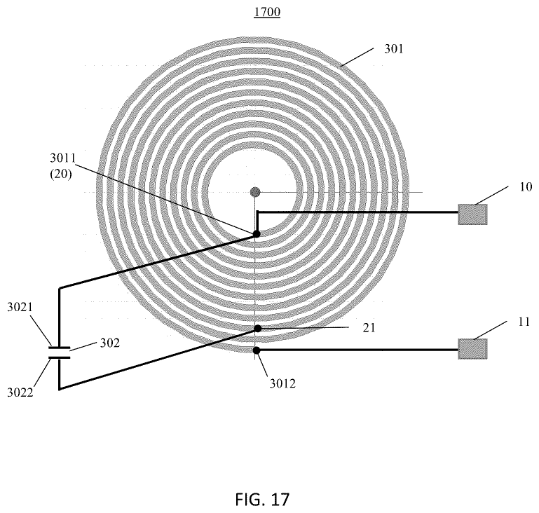

In some embodiments, the second inductive region of the WLC coil is utilized to function as an NFC antenna. FIG. 14 and FIG. 16 show two examples of the second inductive region. The technique is effective up to 35 MHz based on FIG. 16. The WLC turns between terminals 11 and 12 and the WLC turns between terminals 10 and 12 are parallel to each other and function as an NFC antenna as shown in FIG. 1. In other words, all of the WLC turns are utilized and the inductance value for NFC is the inductance value of the paralleled turns between terminals 10 and 12 and terminals 11 and 12 as shown in FIG. 1. The inductance value of the paralleled turns may be quantified with equation (25).

Furthermore, the whole WLC coil (all of the turns between terminals 10 and 11) may function as a normal WLC coil. Terminals 10 and 11 may be connected to a battery for charging. Terminals 11 and 12 (or terminals 10 and 12) may be connected to an NFC IC for data and/or information exchange. The location of the contact point 1013 on the WLC coil 101 determines the inductance value utilized for NFC antenna, which may be quantified with equation (25) in the present disclosure.

In some embodiments, the second inductive region may be expanded by increasing the mutual inductance or using a nanocrystalline or a composite magnetic material with lower permittivity to reduce the parasitic capacitance.

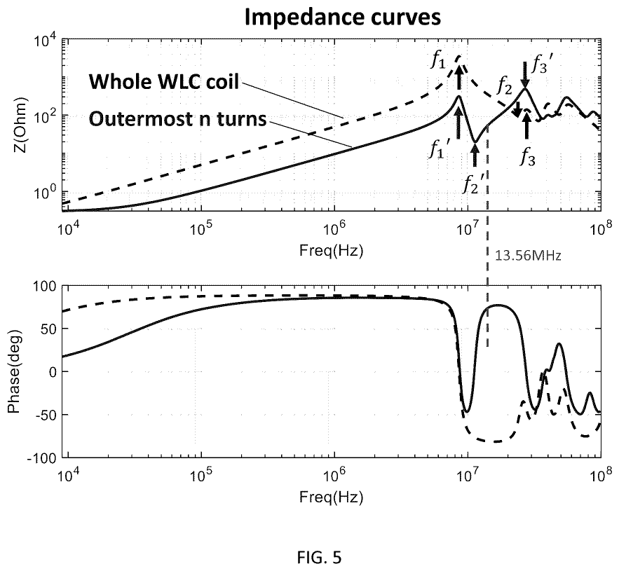

In some embodiments, the WLC and NFC integration technique utilizes the second inductive region (e.g., and not the first inductive region) of the WLC coil to function as an NFC antenna. FIG. 5 illustrates the measured impedance curve of WLC coils deployed in example cellphones.

In some embodiments, the WLC and NFC integration technique utilizes all of the WLC winding turns to function as an NFC antenna.

In some embodiments, the WLC and NFC integration technique only needs one additional terminal for the NFC operation. The location of the contact point 1013 on the WLC coil 101, which electrically connected with the terminal 12, may influence the inductance value for the NFC antenna.

In some embodiments, the WLC and NFC integrations herein are free from (e.g., do not require) any additional electronic components, such as a capacitor.

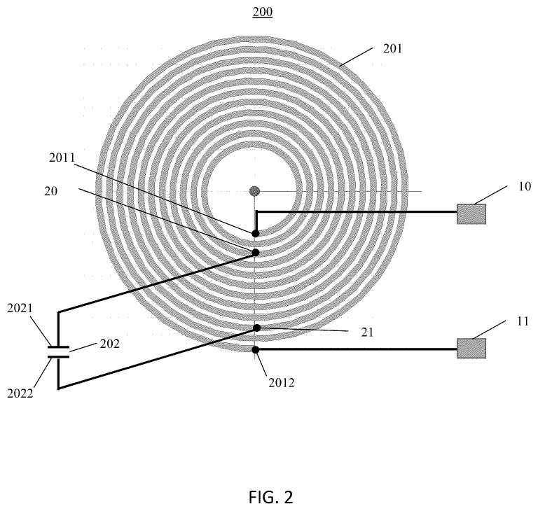

According to some embodiment of the present disclosure, the WLC and NFC integration technique may utilize a frequency selection capacitor to select a portion of the WLC coil to function or operate as the NFC antenna. FIG. 2 provides an example circuit structure diagram for integrating a wireless charging (WLC) coil and a near-field communication (NFC) antenna, according to some embodiments of the present disclosure. It will be appreciated that the locations of contact points on the WLC coil to connect with the C_{fs} are flexible, depending on which portion of WLC coil is utilized for the NFC antenna.

As shown in FIG. 2, an example circuit 200 includes a WLC coil 201, a first terminal 10, a second terminal 11, a third terminal 20, a fourth terminal 21, and a capacitor 202. The WLC coil 201 has a first end 2011, and a second end 2012. The first terminal 10 is electrically connected with the first end 2011 of the WLC coil 201. The second terminal 11 is electrically connected with the second end 2012 of the WLC coil 201. The third terminal 20 and the fourth terminal 21 are two contact points located between the first end 2011 and the second end 2012 of the WLC coil 201. The third terminal 20 and the fourth terminal 21 are electrically connected to a top plate 2021 and a bottom plate 2022 of the capacitor 202.

In some embodiments, the first terminal 10 and the second terminal 11 of the WLC coil 201 may be connected to a battery, such that the WLC coil 201 may help charge the battery wirelessly. The first terminal 10 and the second terminal 11 of the WLC coil 201 may also be connected to an NFC IC, such that the NFC antenna may help the NFC IC to communicate with a target device. In other words, the first terminal 10 and the second terminal 11 of the WLC coil 201 are configured to be multiplexed as a second WLC terminal and a second NFC terminal, respectively.

In some embodiments, the capacitor 202 is a frequency selection capacitor C fs applied to select part of WLC turns at 13.56 MHz to function as an NFC antenna.

In some embodiments, the selection capacitor C_{fs} is nearly an open circuit for WLC operation mode at 150 kHz. Hence, the entire WLC coil 201 may function as a normal WLC coil. Terminals 10 and 11 are connected to a battery for charging in WLC operation mode at 150 kHz.

In some embodiments, the selection capacitor C_{fs} is nearly a short circuit for NFC operation mode at 13.56 MHz. Therefore, the WLC turns in parallel with the selection capacitor C_{fs} (between terminals 20 and 21) are shorted. Terminals 10 and 11 are also connected to the NFC IC for data and/or information exchange in NFC operation mode at 13.56 MHz.

In some embodiments, only the WLC turns that are not in parallel with the C_{fs} are selected for operation as the NFC antenna at 13.56 MHz. In other words, winding turns between terminals 10 and 20 together with winding turns between terminals 11 and 21 are selected as the NFC antenna to function or operate at 13.56 MHz.

In some embodiments, the locations of 20 and 21 in FIG. 2 are flexible, which depend on which portion of the WLC coil 201 is selected as the NFC antenna.

In some embodiments, the capacitance value of C_{fs} is 2-9 nF.

In some embodiments, only the winding turns not in parallel with the C_{fs} are utilized as the NFC antenna (e.g., as opposed to the winding turns between the two C_{fs}), because winding turns between terminals 20 and 21 are bypassed by the C_{fs} at 13.56 MHz.

In some embodiments, the WLC and NFC integration technique utilizes both the outermost several turns and the innermost several turns. Thus, both the NFC antenna physical area and the generated H-field in the center area may be large enough for the near-field communications.

The WLC and NFC integration techniques, as shown in FIG. 1 and FIG. 2, provide savings on both the volume of the coil and the cost to manufacture the coil. For example, the volume of the coil may be reduced approximately 30% and the cost to manufacture the coil may be reduced approximately 50% in some portable electronic products, implantable medical devices, and electric vehicles.

### Example High-Frequency Impedance Characterization of Wireless Charging Coils

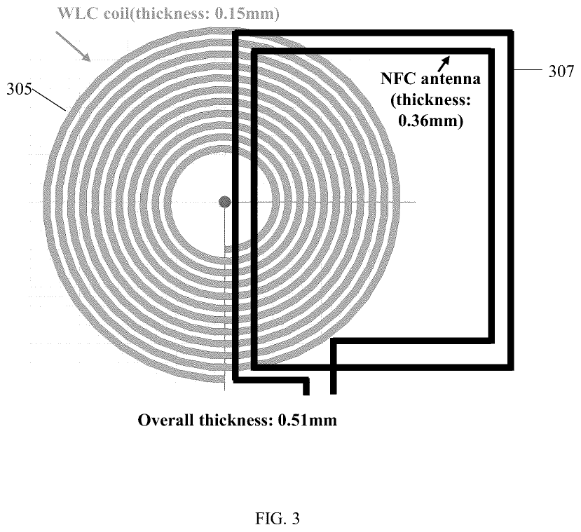

FIG. 3 shows an example prototype of a wireless charging (WLC) coil separate from an NFC antenna. The prototype may be deployed in cellphones.

As shown in FIG. 3, the WLC coil 305 has 11 turns while the NFC antenna 307 only has 2 turns. Integrating the two together may reduce the overall thickness of the coil to 0.15 mm. The impedance characteristics of the outermost/innermost turns of the WLC coil are discussed herein.

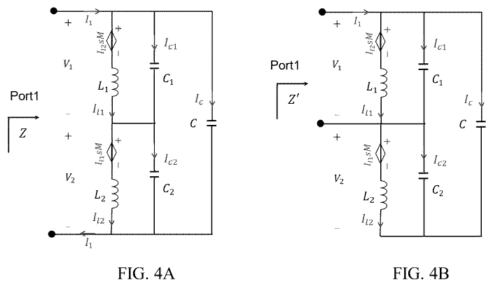

FIGS. 4A and 4B show equivalent circuits of FIG. 1 for the impedance characteristics measured at terminals 10 and 11 and terminals 11 and 12 (the same for terminals 10 and 12), respectively. In FIGS. 4A and 4B, L₁ and L₂ represent inductance values of the outermost n turns and the innermost (11−n) turns of the WLC coil, respectively. M is a mutual inductance between L₁ and L₂. C₁, C₂, and C represent equivalent parasitic capacitance values of the outermost n turns, the innermost (11−n) turns, and the entire WLC coil, respectively.

Based on equivalent circuits in FIGS. 4A and 4B, the equivalent impedances Z and Z′ can be derived in equations (1)-(9) as follows:

I_{c1}=sC₁V₁ (1)

I_{c2}=sC₂V₂ (2)

I_{c}−sC(V₁+V₂) (3)

V₁=sL₁Iₗ₁+sMIₗ₂ (4)

V₂=sL₂Iₗ₂+sMIₗ₁ (5)

Iₗ₁+I_{c1}+I_{c}=I₁ (6)

Iₗ₂+I_{c2}+I_{c}=I₁ (7)

Based on equations (8) and (9), both Z and Z′ have three resonant frequencies, which can be derived as follows. Equations (10)-(12) illustrate the three resonant frequencies for Z (measured at terminals 10 and 11 in FIG. 1) while equations (13)-(15) illustrate the three resonant frequencies for Z′ (measured at terminals 11 and 12 in FIG. 1).

$$\begin{matrix}Z = \vert \frac{{V}_{1} + {V}_{2}}{{I}_{1}} \vert = \frac{s ( {L}_{1} + {L}_{2} + 2 M ) + {s}^{3} ( {L}_{1} {L}_{2} - {M}^{2} ) ( {C}_{1} + {C}_{2} )}{\begin{matrix}1 + {s}^{2} ( {L}_{1} C + {L}_{1} {C}_{1} + {L}_{2} C + {L}_{2} {C}_{2} + 2 MC ) + \\ {s}^{4} ( {L}_{1} {L}_{2} - {M}^{2} ) ( {C}_{1} {C}_{2} + {C}_{2} C + {C}_{1} C )\end{matrix}} & ( 8 ) \\ {Z}^{′} = \vert \frac{{V}_{1}}{{I}_{1}} \vert = \frac{{sL}_{1} + {s}^{3} ( {L}_{1} {L}_{2} - {M}^{2} ) ( {C}_{1} + {C}_{2} )}{\begin{matrix}1 + {s}^{2} ( {L}_{1} C + {L}_{1} {C}_{1} + {L}_{2} C + {L}_{2} {C}_{2} + 2 MC ) + \\ {s}^{4} ( {L}_{1} {L}_{2} - {M}^{2} ) ( {C}_{1} {C}_{2} + {C}_{2} C + {C}_{1} C )\end{matrix}} & ( 9 ) \\ {f}_{1} = \frac{1}{2 π \sqrt{( {L}_{1} + {L}_{2} + 2 M ) C + {L}_{1} {C}_{1} + {L}_{2} {C}_{2}}} & ( 10 ) \\ {f}_{2} = \frac{1}{2 π \sqrt{\frac{( {L}_{1} {L}_{2} - {M}^{2} ) ( {C}_{1} + {C}_{2} )}{{L}_{1} + {L}_{2} + 2 M}}} & ( 11 ) \\ {f}_{3} = \frac{1}{2 π \sqrt{\frac{( {L}_{1} {L}_{2} - {M}^{2} ) ( {C}_{1} {C}_{2} + {C}_{2} C + {C}_{1} C )}{( {L}_{1} + {L}_{2} + 2 M ) C + {L}_{1} {C}_{1} + {L}_{2} {C}_{2}}}} & ( 12 ) \\ {f}_{1}^{′} = \frac{1}{2 π \sqrt{( {L}_{1} + {L}_{2} + 2 M ) C + {L}_{1} {C}_{1} + {L}_{2} {C}_{2}}} & ( 13 ) \\ {f}_{2}^{′} = \frac{1}{2 π \sqrt{\frac{( {L}_{1} {L}_{2} - {M}^{2} ) ( C + {C}_{2} )}{{L}_{1}}}} & ( 14 ) \\ {f}_{3}^{′} = \frac{1}{2 π \sqrt{\frac{( {L}_{1} {L}_{2} - {M}^{2} ) ( {C}_{1} {C}_{2} + {C}_{2} C + {C}_{1} C )}{( {L}_{1} + {L}_{2} + 2 M ) C + {L}_{1} {C}_{1} + {L}_{2} {C}_{2}}}} & ( 15 )\end{matrix}$$

It can be concluded from equations (10)-(15) that the entire WLC coil and part of the WLC coil always have the same first and third resonant frequencies. The only difference lies in the second resonant frequencies. Therefore, to utilize part of the WLC coil as the NFC antenna, the first resonant frequency is determined by the entire WLC coil's first resonant frequency, which is usually smaller than 10 MHz due to the large EPC (e.g., caused by the large number of turns) and cannot meet the requirements of the NFC antenna. The measured impedance curves for the entire WLC coil (Z) and the outermost n turns (Z′) are shown in FIG. 5, which support the above analysis.

Further, based on the resonant frequencies, the impedance characteristics of the outermost n turns of the WLC coil can be divided into 4 regions, which may be also verified in FIG. 5. Based on FIG. 5 and equations (10)-(15), the parasitic capacitors, inductors, and mutual inductance in FIGS. 4A and 4B can be obtained as: C=10 pF, C₁=95 pF, C₂=62 pF, L₁=0.8 μH, L₂=5.2 μH, and M=1.1 μH.

When f<f₁′, the frequency is in the first inductive region and the inductance value is approximately the self-inductance value as expressed in equation (16). When f₁′<f<f₂′, the frequency is in the first capacitive region and the capacitance value is expressed in equation (17). When f₂′<f<f₃′, the frequency is in the second inductive region and the inductance value is expressed in equation (18). When f>f₃′, the frequency is in the second capacitive region and the capacitance value is expressed in equation (19).

$$\begin{matrix}{Z}_{1}^{′} = {sL}_{1} & ( 16 ) \\ {Z}_{2}^{′} = \frac{1}{s \frac{( {L}_{1} + {L}_{2} + 2 M ) C + {L}_{1} {C}_{1} + {L}_{2} {C}_{2}}{{L}_{1}}} & ( 17 ) \\ {Z}_{3}^{′} = s \frac{( {L}_{1} {L}_{2} - {M}^{2} ) ( C + {C}_{2} )}{( {L}_{1} + {L}_{2} + 2 M ) C + {L}_{1} {C}_{1} + {L}_{2} {C}_{2}} & ( 18 ) \\ {Z}_{4}^{′} = \frac{1}{s \frac{( {C}_{1} {C}_{2} + {C}_{2} C + {C}_{1} C )}{( C + {C}_{2} )}} & ( 19 )\end{matrix}$$

It can be concluded that there is always a second region for the outermost (the same for the innermost) n turns of the WLC coil. Meanwhile, the second region covers the frequency of 13.56 MHz based on the measured curve in FIG. 5. Thus, the second region may be further investigated and utilized for the NFC antenna. The bandwidth of the second inductive region may be determined by the f₂′ and f₃′, which are expressed in equations (14)-(15).

### Example Second Inductive Region Impedance Considering Load Effect of Wireless Charging

To integrate the WLC coil and the NFC antenna together and apply in practical applications (e.g., cellphones, earbuds, implantable devices, etc.), the load effect from the WLC and NFC must be considered to guarantee the normal operations for both the near-field communication and the wireless charging.

### Load Effect for NFC Operation Mode Due to Wireless Charging

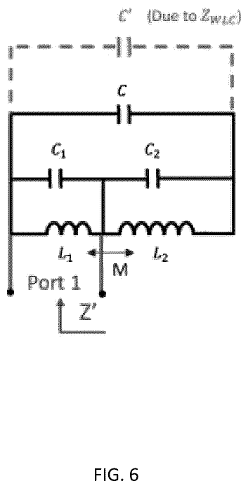

For the WLC coil to operate in NFC antenna mode, the wireless charging load effect may be considered. The WLC load is usually a capacitor with several nF capacitance value. P9412 is a 30 W Rx modulation component widely deployed in cellphone applications. Based on the datasheet of P9412, when the WLC coil is not working for battery charging, the WLC load is a 3 nF capacitor. Thus, an equivalent circuit model for the WLC coil to operate in NFC mode considering WLC load effect is shown in FIG. 6.

In FIG. 6, C′ represents the WLC load effect. C₁, C₂, and C are typically tens of pF of the WLC coil (based on extracted impedance curve in FIG. 5), and they are much smaller than C′. Therefore, the equivalent (C+C′)≈C′ is much larger than C₁ and C₂. Thus, the three resonant frequencies of equations (13)-(15) can be further simplified into equations (20)-(22).

$$\begin{matrix}{f}_{1}^{′} \approx \frac{1}{2 π \sqrt{( {L}_{1} + {L}_{2} + 2 M ) {C}^{′}}} & ( 20 ) \\ {f}_{2}^{′} \approx \frac{1}{2 π \sqrt{\frac{( {L}_{1} {L}_{2} - {M}^{2} ) {C}^{′}}{{L}_{1}}}} & ( 21 ) \\ {f}_{3}^{′} = \frac{1}{2 π \sqrt{\frac{( {L}_{1} {L}_{2} - {M}^{2} ) ( {C}_{1} + {C}_{2} )}{{L}_{1} + {L}_{2} + 2 M}}} & ( 22 )\end{matrix}$$

At the same time, the inductance/capacitance value in every inductive/capacitive region can be further simplified into equations (23)-(26).

$$\begin{matrix}{L}_{eq 1} \approx {L}_{1} & ( 23 ) \\ {C}_{eq 1} \approx \frac{( {L}_{1} + {L}_{2} + 2 M ) {C}^{″}}{{L}_{1}} & ( 24 ) \\ {L}_{eq 2} \approx \frac{{L}_{1} {L}_{2} - {M}^{2}}{{L}_{1} + {L}_{2} + 2 M} & ( 25 ) \\ {C}_{eq 2} \approx {C}_{1} + {C}_{2} & ( 26 )\end{matrix}$$

It is clear that the inductance value in the second inductive region is only related to L₁, L₂, and M, which may not be influenced by the WLC load effect (C′) and the equivalent parasitic capacitors (C, C₁, and C₂).

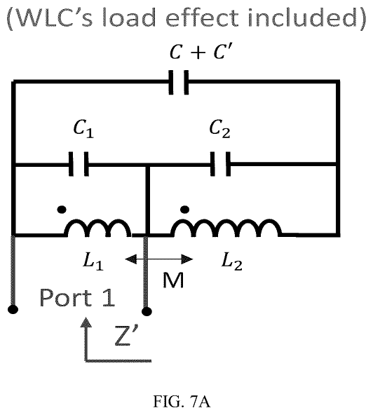

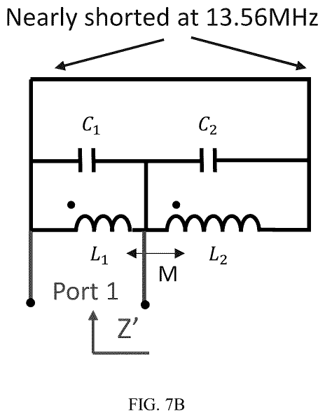

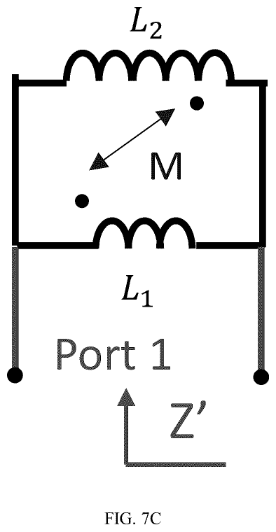

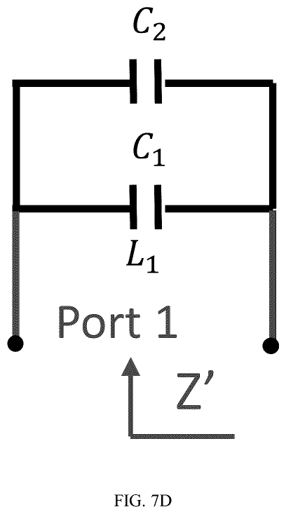

The equivalent circuits for impedance of the second inductive region's inductor is illustrated in FIGS. 7A, 7B, 7C, and 7D. Since 3 nF (C′) is nearly a short circuit at 13.56 MHz for NFC operation. Thus, L₁-C₁ branch and L₂-C₂ branch are actually in parallel at high frequencies. For example, WLC turns between terminals 10 and 12 are in parallel with WLC turns between terminals 11 and 12 directly at high frequencies like 13.56 MHz as shown in FIG. 1.

Before the third resonant frequency f₃′, the equivalent inductor L_{eq2} as expressed in equation (25) is the paralleled inductance value of the outermost n turns (between terminals 11 and 12) and the innermost (11−n) turns (between terminals 10 and 12) of the WLC coil as shown in FIG. 7(C). After the third resonant frequency f₃′, the equivalent capacitor C_{eq2} as expressed in equation (26) is the paralleled capacitance value of the outermost n turns and the innermost (11−n) turns of the WLC coil as shown in FIG. 7(D).

It should be noted that in the second inductive region, both the outermost n turns (between terminals 11 and 12) and the innermost (11−n) turns (between terminals 10 and 12) are utilized. All the WLC winding turns are fully used. The location of the terminal 12 in FIG. 1 only influences the inductance value L_{eq2} in the second inductive region, and thus the location may be chosen based on the required inductance value for the NFC antenna.

In the present disclosure, the NFC antenna is designed to be around 0.4 μH to fully utilize a matching network. Hence, the terminal 12 is located in the outermost 2 turns as shown in FIG. 1.

### Load Effect for WLC Operation Mode Due to NFC IC

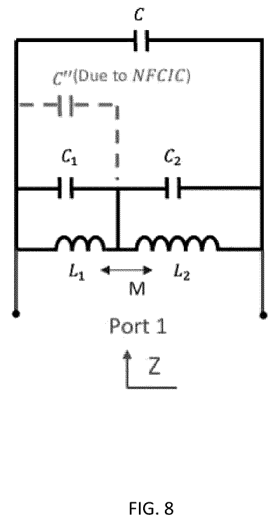

For a WLC coil that operates in a WLC mode, NFC IC load effect may also be considered. An NFC IC load is usually a capacitor with tens of hundreds of pF capacitance value. C″ represents the load effect as illustrated in FIG. 8.

Since the wireless charging mode is operating in the first inductive region, which is around 150 kHz for most of the cellphone applications based on Qi standard, only the first resonant frequency needs to be considered, which is much larger than 150 kHz to guarantee the normal operation of battery charging. Based on the extracted impedance curve in FIG. 5, the resonant frequency for the WLC coil is nearly 8 MHz, which is much larger than 150 kHz.

Since the value of C″ is close to C₁, C₂, and C and the inductance value of L₁ is smaller than (L₁+L₂+2M), based on equation (10), the influence on the WLC operation due to NFC IC load effect is limited.

Based on the above analysis, only the WLC load effect may be considered when the coil operates in NFC mode at 13.56 MHz for the WLC and NFC integration.

### Example Simulation and Experiment Verification

To fully verify the analysis, simulations and experiments were conducted. The simulations may be conducted in Simulink and extracted parasitic parameters were used.

### Simulation Validation

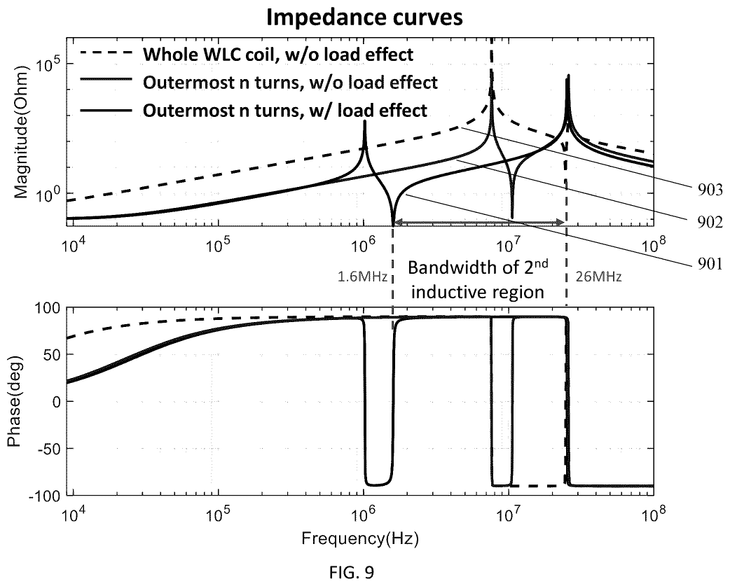

First, the impedance curve was simulated in Simulink as shown in FIG. 9. With the 3 nF WLC load effect included, the first resonant frequency of the outermost n turns is moved to a much smaller value around 1 MHz (as shown by curve 901). The original third resonant frequency of the outermost n turns (as shown by curve 902) is moved to a location of the second resonant frequency of the original whole WLC coil (as shown by curve 903), which is around 26 MHz. The simulated impedance curve and new resonant frequencies can match the calculated results with equations (20)-(22) very well. A bandwidth of the second inductive region is from 1 MHz to 26 MHz, and an NFC operation frequency of 13.56 MHz is exactly in the middle of the inductive region.

It should be noted the amplitudes of the impedance curve at three resonant frequencies will not influence the analysis and the WLC and NFC integration technique in the present disclosure. The magnitude of the impedance of the WLC coil has spikes and valleys, which may be influenced by the AC winding resistance of the coil and the magnetic core loss due to the nanocrystalline applied in WLC coil.

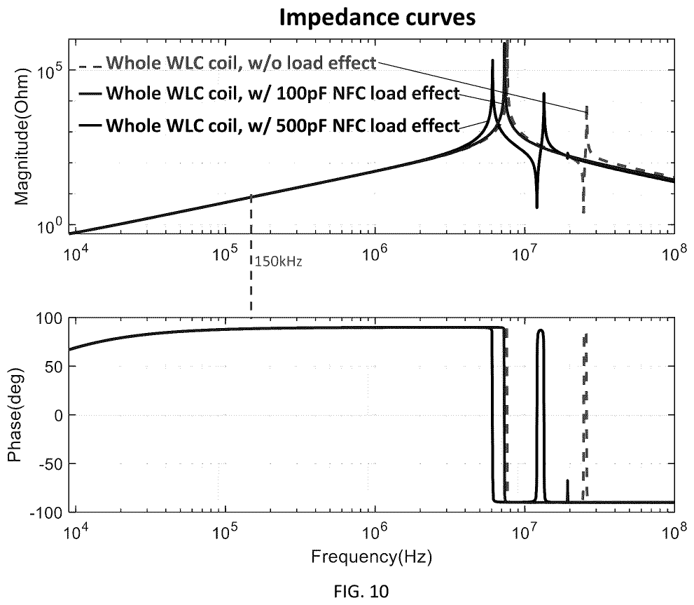

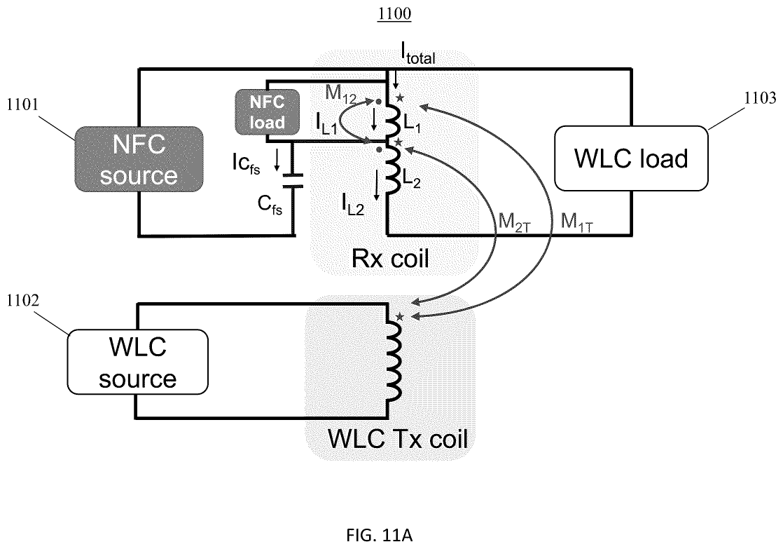

Second, the NFC IC load effect was simulated when the integrated coil is working in the WLC mode at 150 kHz as shown in FIG. 10. The first resonant frequency f₁′ has almost no change, which may be close to 7 MHz (100 pF load effect) and much higher than the 150 kHz. The margin may be large enough for the normal operation of WLC mode.

Based on the above simulation results, the only load effect that needs to be considered for practical applications is the WLC load effect C′ when the coil operates in an NFC mode at 13.56 MHz. The bandwidth of the second inductive region must cover the frequency of 13.56 MHz.

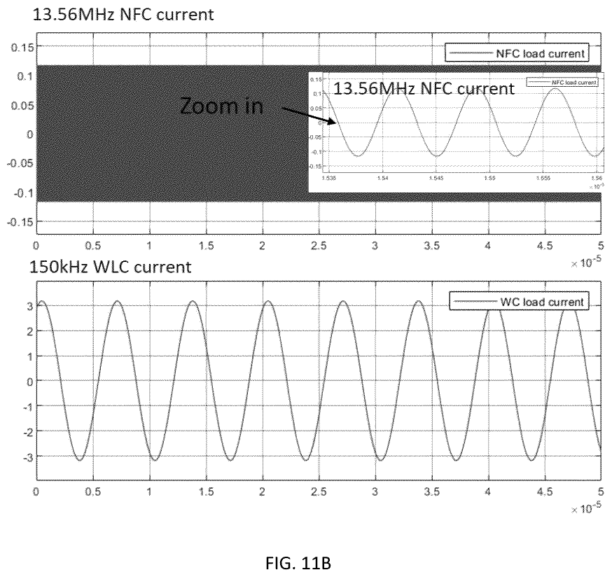

Furthermore, simulations were conducted in Simulink to check the current distribution of different frequencies of excitation current. The setup 1100 in Simulink is shown in FIG. 11A. For example, WLC source 1102 may be a wireless charger (Tx) and function or operate at 150 kHz, while NFC source 1101 may be an NFC IC and function or operate at 13.56 MHz. Electric currents in the WLC load 1103 (for example, a cellphone battery) and the NFC load (for example, an NFC card or a Rx receiver) are shown in FIG. 11B. It is successfully verified as shown in FIG. 11B that the 13.56 MHz NFC current flows in the NFC load while the 150 kHz wireless charging current flows in the WLC load. In other words, the WLC and NFC integration technique can achieve the goal for the WLC and the NFC to work simultaneously.

### Experimental Validation

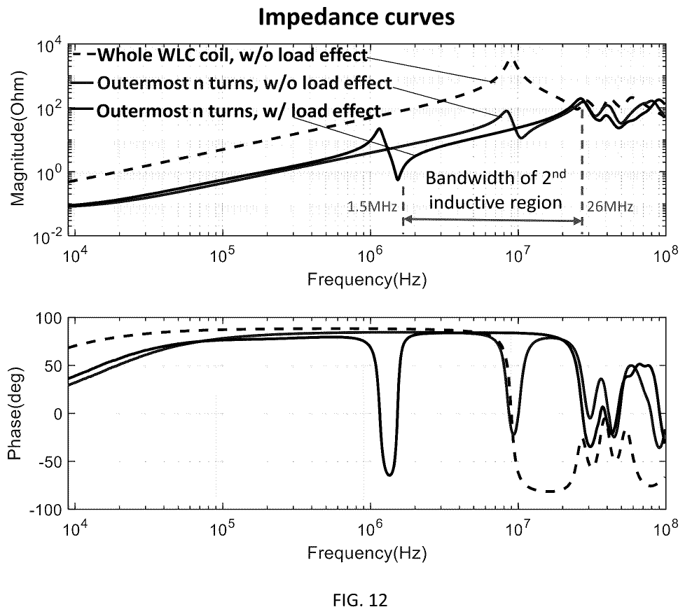

First, to consider the WLC load effect C′ when the coil operates in NFC operation mode at 13.56 MHz, the impedance curve is extracted experimentally, as shown in FIG. 12. The measured curve with 3 nF load effect considered matches the simulation and theoretical results very well, and the new f₃′ moves to the location of f₂ of the whole WLC coil without the 3 nF load effect. The bandwidth of the second inductive region is 1.5 MHz-26 MHz, which matches the simulated result of 1.6 MHz-26 MHz very well and covers the 13.56 MHz very well.

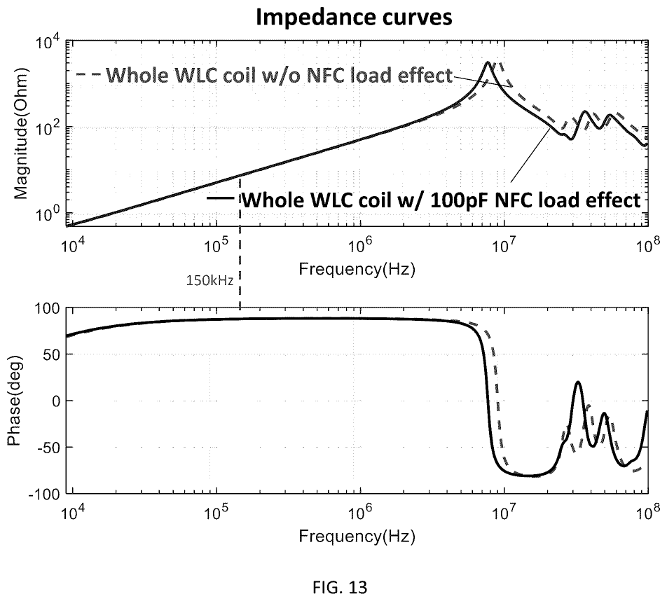

Second, to consider the NFC IC load effect C″ when the coil operates in WLC operation mode at 150 kHz, the impedance curve is extracted experimentally, as shown in FIG. 13. The measured curve with 100 pF load effect considered matches the simulation and theoretical results very well, and the new f₁ does not change too much compared to the entire WLC coil baseline case (without the 100 pF load), which is around 7 MHz and much larger than 150 kHz. The margin is large enough for the normal operation of the WLC coil with the NFC IC's load effect.

### Inductance Value in the Second Inductive Region

The inductance value quantified in equation (25) was also verified for the second inductive region. Based on the measured impedance curve in FIG. 14, the impedance is 0.38 μH at 13.56 MHz, which matches the calculated result 0.36 μH based on equation (25) very well and is very close to the impedance of an existing separate NFC antenna. Thus, the integration technique of the present disclosure can meet the inductance value requirements for the NFC operation.

Based on the above simulation and experiment results, the presented formulas for the resonant frequencies and the equivalent inductance value in the second inductive region are fully verified.

### Example Techniques to Expand Second Inductive Region Bandwidth

To apply the WLC and NFC integration techniques in practical products, expanding the second inductive region bandwidth of the WLC coil is considered herein.

### Mutual Inductance Increase

Based on the presented equations (21)-(22), increasing the mutual inductance M between L₁ and L₂ can greatly help expanding the bandwidth of the second inductive region.

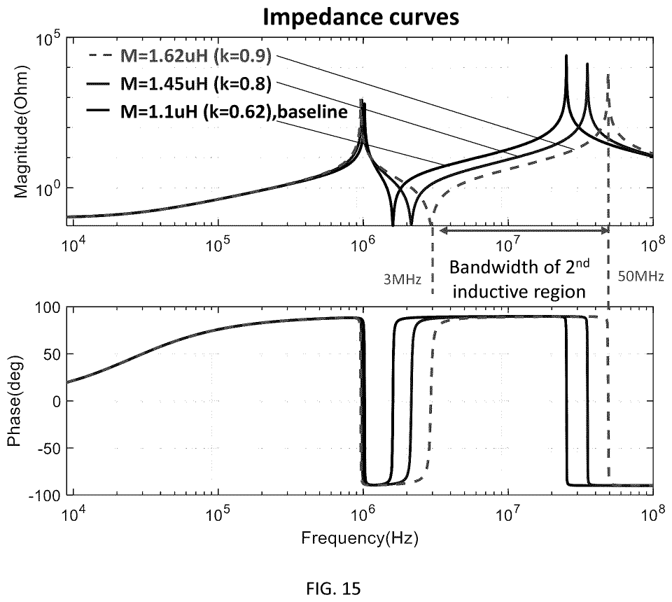

Simulation was conducted in Simulink and the result is shown in FIG. 15. It is clear that the bandwidth is significantly increased. The second resonant frequency (impedance valley) is smaller enough (e.g., 3 MHz) compared to 13.56 MHz, even when k=0.9 (k is a coupling coefficient between L₁ and L₂) while the third resonant frequency (impedance peak) is close to 50 MHz. The presented idea to expand the bandwidth is successfully verified in simulation and the bandwidth is increased from a range of 1.6 MHz-26 MHz to a range of 3 MHz-50 MHz.

### Magnetic Material with Lower Permittivity

Based on the presented equations (21)-(22), decreasing the parasitic capacitance value C₁ and C₂ can greatly help expanding the bandwidth of the second inductive region, which can be achieved by using a nanocrystalline or a composite magnetic material with a low permittivity. FIG. 16 shows the measured impedance curve with the nanocrystalline and ferrite composite material with a low permittivity. The second inductive region is further expanded from a range of 1.6 MHz-26 MHz to a range of 1.3 MHz-35 MHz.

### Example Alternative Embodiments

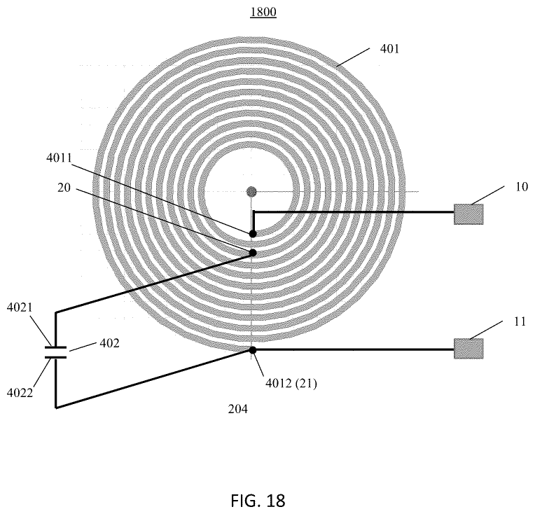

In another embodiments, an alternative technique is introduced to integrate a WLC coil and an NFC antenna according to some embodiments of the present disclosure. For example, in earbud applications, the EPC is not large for the WLC coils and the WLC load effect C′ can be neglected. In other words, the number of the winding turns of the WLC coil is small like the one deployed in an earbud. In this case, the first resonant frequency of the WLC coil could be higher than 13.56 MHz. Thus, the first inductive region can still be utilized for the NFC operation. Therefore, an integration technique based on the selection of winding turns is introduced as shown in FIG. 2, FIG. 17, and FIG. 18.

As shown in FIG. 17, an example circuit 1700 includes a WLC coil 301, a first terminal 10, a second terminal 11, a third terminal 20, a fourth terminal 21, and a capacitor 302. In some examples, the WLC coil 101 may be formed in a circular shape or an oval shape. The WLC coil 301 has a first end 3011, and a second end 3012. The first terminal 10 is electrically connected with the first end 3011 of the WLC coil 301. The second terminal 11 is electrically connected with the second end 3012 of the WLC coil 301. The fourth terminal 21 is a contact point located between the first end 3011 and the second end 3012 of the WLC coil 301. In some examples, a position of the contact point depends on an inductance value of the NFC antenna. The first end 3011 is multiplexed as the third terminal 20. The third terminal 20 and the fourth terminal 21 are electrically connected to a top plate 3021 and a bottom plate 3022 of the capacitor 302.

In some embodiments, the first terminal 10 and the second terminal 11 of the WLC coil 301 may be connected to a battery, such that the WLC coil may help charge the battery wirelessly. The first terminal 10 and the second terminal 11 of the WLC coil 301 may also be connected to an NFC IC, such that the NFC antenna may help the NFC IC to communicate with a target device. In other words, the first terminal 10 and the second terminal 11 of the WLC coil 301 are configured to be multiplexed as a second WLC terminal and a second NFC terminal, respectively.

In some embodiments, the capacitor 302 is a frequency selection capacitor C_{fs} (several nF) applied for the WLC and NFC integration and the frequency selection capacitor C_{fs} has a large impedance at 150 kHz while is nearly a short-circuit at 13.56 MHz.

For example, the winding turns in parallel with the capacitor C_{fs} (between terminals 20 and 21) may be bypassed by the capacitor C_{fs} at 13.56 MHz. Only the winding turns not in parallel with the C_{fs} (winding turns between terminals 10 and 20 together with winding turns between terminals 11 and 21) are utilized as the NFC antenna. In this way, both the innermost several turns and the outermost several turns are utilized for NFC antenna, and the generated H-field in the center area may be greatly enhanced, which is helpful for reliable data and/or information exchange.

All of the WLC turns between terminals 10 and 11 are utilized for wireless charging as a WLC coil at 150 kHz. The C_{fs} may not influence the operation of the wireless charging.

In summary, the C_{fs} passes the 13.56 MHz NFC current while blocks the 150 kHz WLC current (Qi). For example, a C_{fs} of 3 nF is nearly a short circuit at 13.56 MHz while has a resistance greater than 350 Ω at 150 kHz (reference: impedance for 10 uH is 9 Ω at 150 kHz).

In some embodiments, a location of the fourth terminal 21, which is connected with the capacitor C_{fs}, is flexible. The location of the fourth terminal 21 may depend on how much inductance value is needed and which portion of WLC coil is selected for operation as the NFC antenna.

FIG. 18 provides another example circuit structure diagram for integrating a wireless charging (WLC) coil and a near-field communication (NFC) antenna, according to some embodiments of the present disclosure. In FIG. 18, only the innermost turns are used as an NFC antenna, where the outermost turns are bypassed by a selection capacitor.

As shown in FIG. 18, an example circuit 1800 includes a WLC coil 401, a first terminal 10, a second terminal 11, a third terminal 20, a fourth terminal 21, and a capacitor 402. The WLC coil 401 has a first end 4011, and a second end 4012. The first terminal 10 is electrically connected with the first end 4011 of the WLC coil 401. The second terminal 11 is electrically connected with the second end 4012 of the WLC coil 401. The third terminal 20 is a contact point located between the first end 4011 and the second end 4012 of the WLC coil 401. In some examples, a position of the contact point depends on an inductance value of the NFC antenna. The second end 4012 is multiplexed as the fourth terminal 21. The third terminal 20 and the fourth terminal 21 are electrically connected to a top plate 4021 and a bottom plate 4022 of the capacitor 402.

In some embodiments, the first terminal 10 and the second terminal 11 of the WLC coil 401 may be connected to a battery, such that the WLC coil may help charge the battery wirelessly. The first terminal 10 and the second terminal 11 of the WLC coil 401 may also be connected to an NFC IC, such that the NFC antenna may help the NFC IC to communicate with a target device. In other words, the first terminal 10 and the second terminal 11 of the WLC coil 401 are configured to be multiplexed as a second WLC terminal and a second NFC terminal, respectively.

In some embodiments, the capacitor 302 is a frequency selection capacitor C_{fs}. As for the WLC coil operates in the WLC mode at 150 kHz, the C_{fs} is nearly an open circuit, and the influence of the capacitor C_{fs} may be neglectable.

### Analysis of Second Inductance of NFC Antenna

In some embodiments, a H-field distribution and a current distribution of the integrated coil may be analyzed with a finite-element-simulation software (HFSS) to reveal the physical meanings of the second-stage inductance.

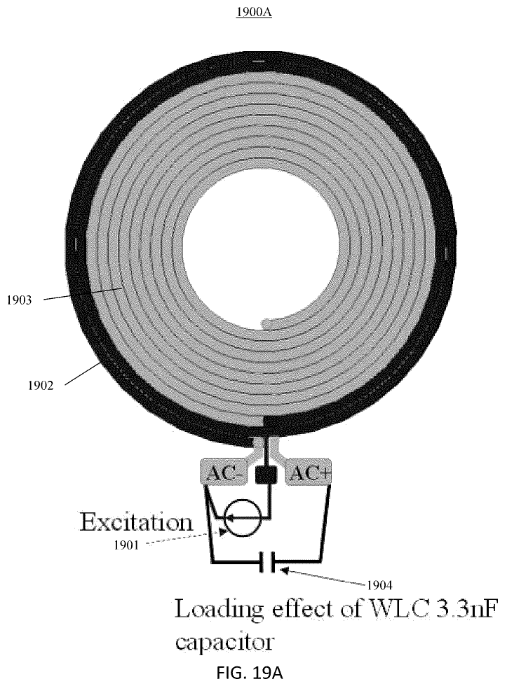

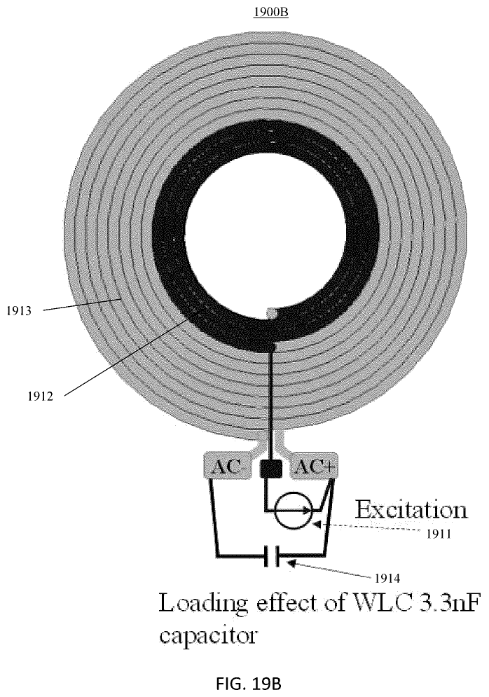

FIG. 19A provides an example simulation setup diagram 1900A for integrating a wireless charging (WLC) coil and a near-field communication (NFC) antenna, according to some embodiments of the present disclosure. As shown in FIG. 19A, for example, an excitation 1901 may be added at the outermost 2 turns 1902 of the WLC coil 1903. In some examples, a 3.3 nF capacitor 1904 may be connected to the WLC coil terminal to imitate the WLC circuit's loading effect of the WLC coil 1903.

FIG. 19B provides an example simulation setup diagram 1900B for integrating a wireless charging (WLC) coil and a near-field communication (NFC) antenna, according to some embodiments of the present disclosure. As shown in FIG. 19B, for example, an excitation 1911 may be added at the innermost 3 turns 1912 of the WLC coil 1913. In some examples, a 3.3 nF capacitor 1914 may be connected in parallel with the WLC coil 1913 to imitate the WLC circuit's loading effect of the WLC coil 1913.

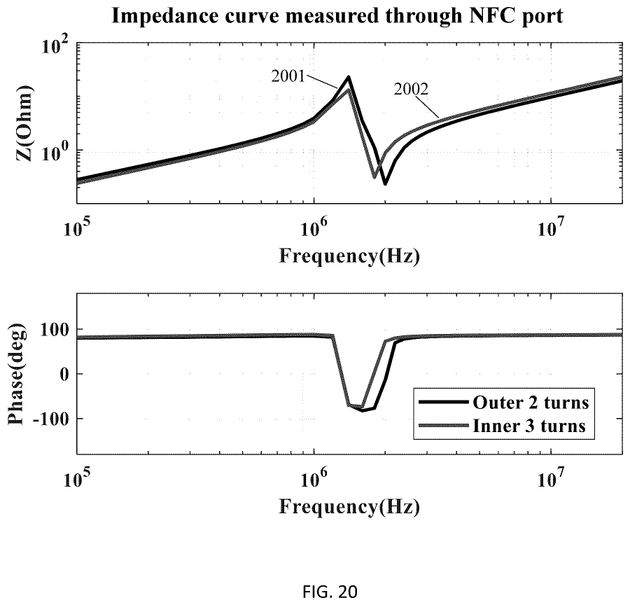

FIG. 20 provides example simulated impedance curves of WLC coils detected at an NFC port, according to some embodiments of the present disclosure. For example, curve 2001 demonstrates the simulated impedance of the WLC coils 1903 detected at the NFC port. For example, curve 2002 demonstrates the simulated impedance of the WLC coils 1913 detected at the NFC port. As shown in FIG. 20, at a low-frequency range (e.g., the frequency is smaller than 1 MHz), the impedances are inductively dominant (as shown by curves 2001 and 2002). In some examples, the first peak may occur when the frequency increases. In some examples, the impedances may be transferred from being dominant by inductance to be dominant by capacitance. Furthermore, in some examples, a first valley may show up, and the impedances may change to a second-stage inductance.

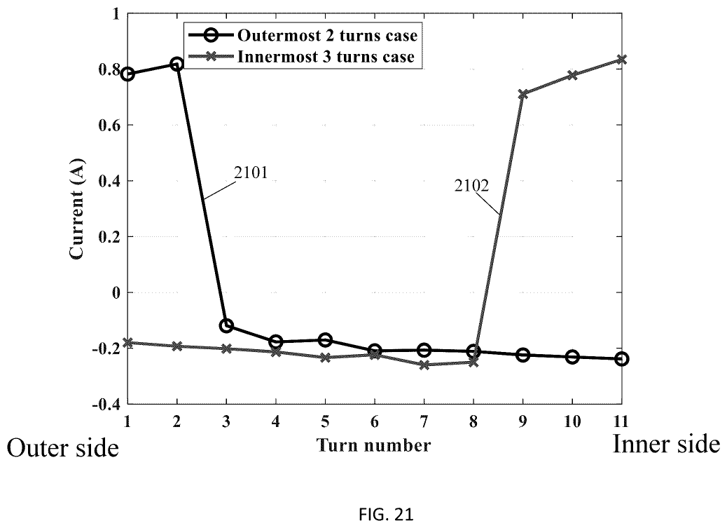

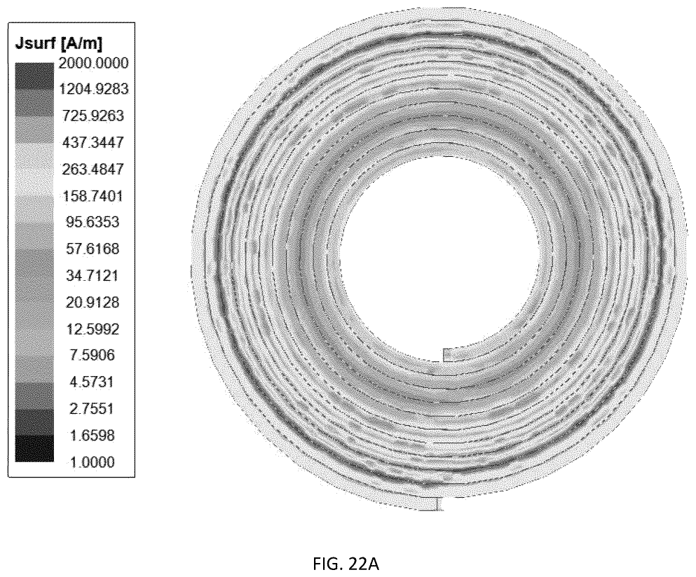

FIG. 21 provides example curves of a current distribution of each turn of an NFC antenna, according to some embodiments of the present disclosure. For example, curve 2101 demonstrates the current distribution of the WLC coils 1903 detected at the NFC port. For example, curve 2102 demonstrates the current distribution of the WLC coils 1913 detected at the NFC port.

For example, the distributed current in each turn and the magnetic field distribution in space may indicate inherent features of the inductor. In some examples, current in each turn is illustrated in FIG. 21 with a 1 A current excitation (13.56 MHz) at the NFC port. For example, curve 2101 demonstrates that the outermost 2 turns 1902 may have a positive current (about 0.8 A) and the remaining turns may have a negative current (about −0.2 A). For example, curve 2102 demonstrates that the outmost 3 turns 1912 may have a positive current (about 0.8 A) and the remaining turns may have a negative current (about −0.2A).

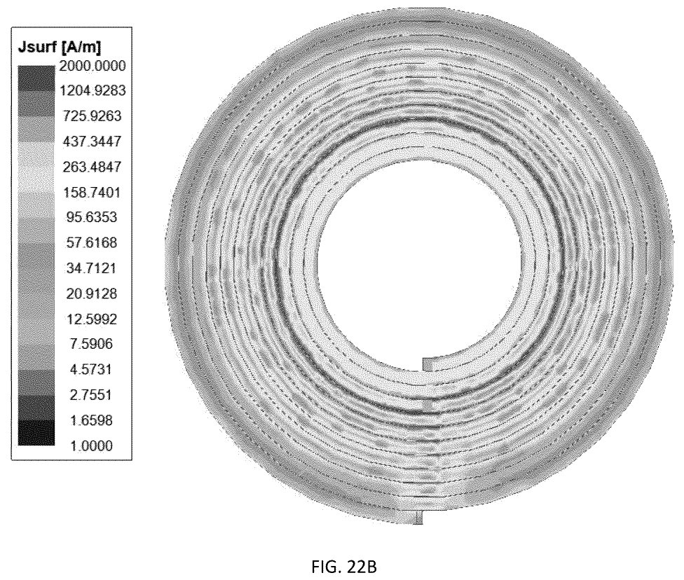

FIG. 22A provides an example diagram of a current distribution of an NFC antenna, according to some embodiments of the present disclosure. For example, as shown in FIG. 22A, the current in the outermost two turns are much larger than that of remaining turns. A maximum current density may be detected at a boundary between the outermost 2 turns and the remaining turns.

FIG. 22B provides an example diagram of a current distribution of an NFC antenna, according to some embodiments of the present disclosure. For example, as shown in FIG. 22B, the current in the innermost three turns is much larger than that of remaining turns. A maximum magnetic field may be detected at a boundary between the innermost three turns and the remaining turns.

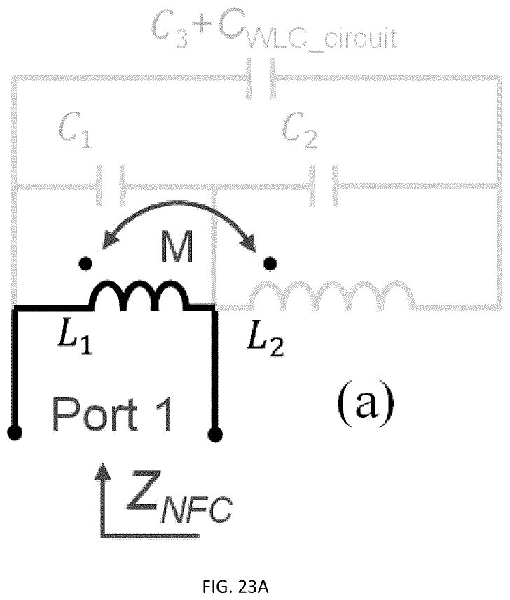

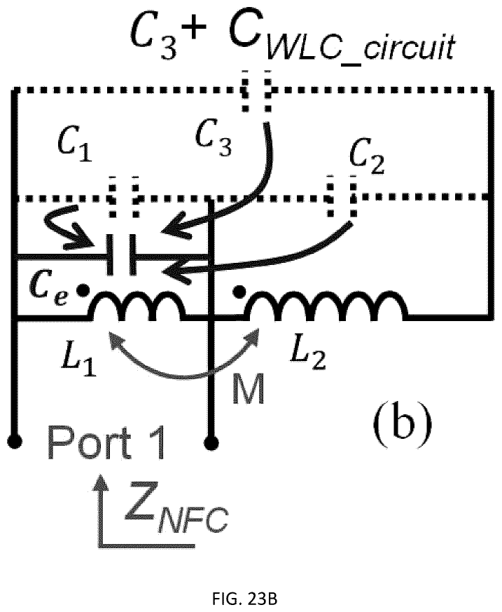

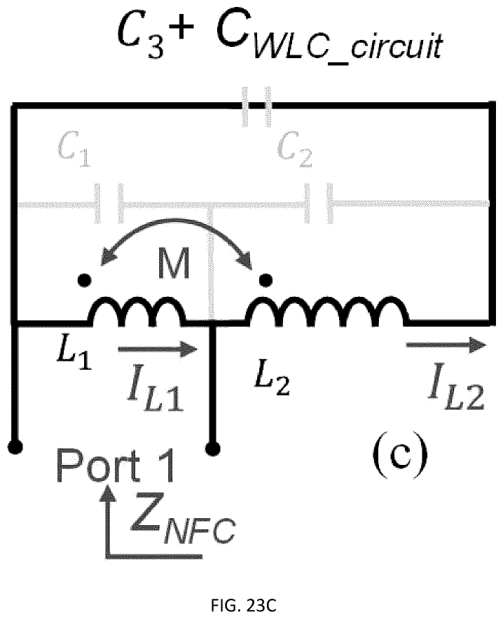

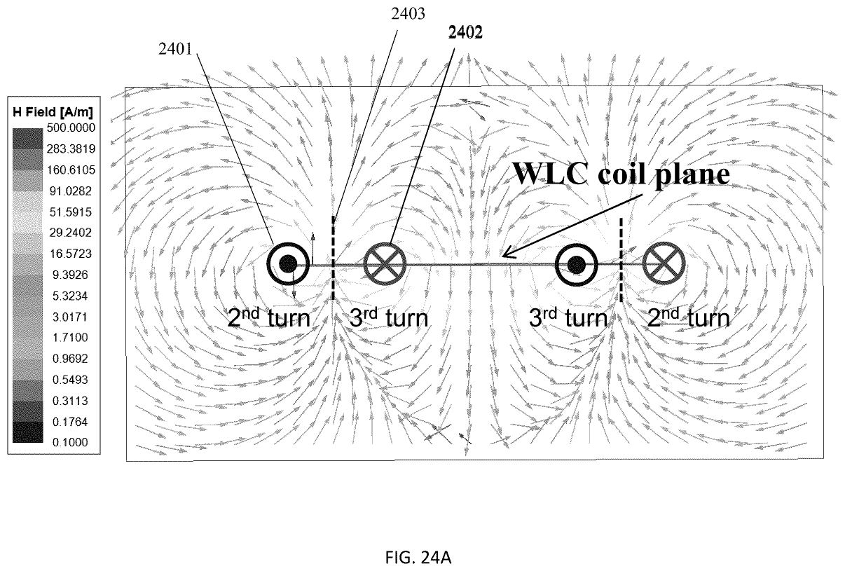

FIG. 23A provides an equivalent circuit diagram for integrating a WLC coil and an NFC antenna at a first NFC working frequency, according to some embodiments of the present disclosure.

For example, as shown in FIG. 23A, at the first NFC working frequency (e.g., the frequency is smaller than 1 MHz), capacitive reactance of C₁, C₂, or C_{WLC_circuit} is much larger than inductive reactance of L₁. As a result, impedance detected from the NFC port may be dominated by the impedance of L₁.

FIG. 23B provides an equivalent circuit diagram for integrating a WLC coil and an NFC antenna at a second NFC working frequency, according to some embodiments of the present disclosure.

For example, as the NFC working frequency increases, the inductive reactance of L₁ may increase, and the capacitive reactance of Ce, which is an equivalent capacitance from C₁, C₂, and C₃+C_{WLC_circuit} based on the approximate equation of first stage capacitance shown in TABLE I, may decrease. In some examples, as shown in FIG. 23B, when the capacitive reactance of Ce is smaller than the inductive reactance of L₁, the impedance detected from the NFC port may be dominated by the capacitive reactance of Ce.

FIG. 23C provides an equivalent circuit diagram for integrating a WLC coil and an NFC antenna at a third NFC working frequency, according to some embodiments of the present disclosure.

For example, as the NFC working frequency further increases, a branch of C3+C_{WLC_circuit} may be treated as a short-circuit since C₃+C_{WLC_circuit} is about 3.3 nF, which is much larger than the capacitance of C₁ and C₂. As a result, L₁ and L₂ are connected in anti-parallel as shown in FIG. 23C. In some examples, the impedances of C₂ and C₃ are much larger than that of L₁ and L₂ in an anti-parallel connection, which may be dominant in the impedance detected from the NFC port. In some examples, the current i_{L1} in L₁ and the current i_{L2} in L₂ may have opposite directions due to the anti-parallel connection between L₁ and L₂.

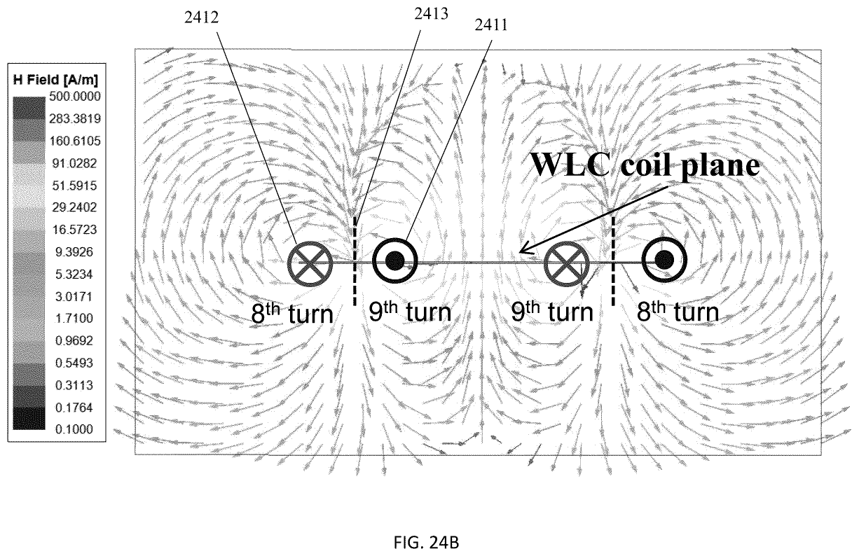

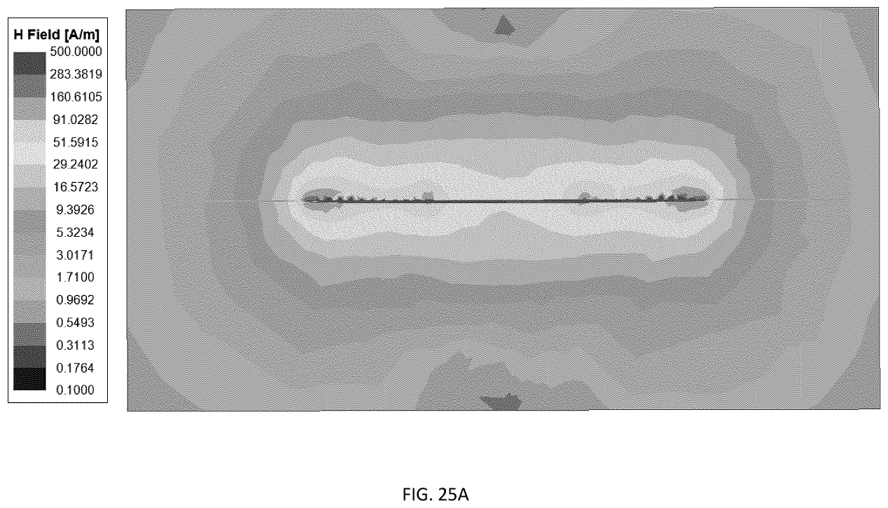

FIG. 24A provides an example diagram of a H-field vector distribution of an NFC antenna using the outermost two turns 1902, according to some embodiments of the present disclosure.

In some embodiments, second-stage inductance due to the anti-parallel connection between L₁ and L₂ may generate a different magnetic field distribution with respect to that of first-stage inductance. For example, the NFC antenna may be axially symmetric, and the magnetic field on a plane, which is perpendicular to a WLC coil plane, may be observed to demonstrate the magnetic field distribution of the NFC antenna. As shown in FIG. 24A, vectors of H-field on the observed plane are demonstrated when the NFC antenna is using the outermost two turns 1902. In some examples, the vectors of the H-field on the observed plane may be observed when the magnitude of the excitation current is maximum.

In some examples, current 2401 in the outermost 2 turns 1902 may flow out of the plane as indicated by a dot symbol. For example, the current 2401 may generate a counterclockwise magnetic field. In some examples, current 2402 in remaining turns may flow into the plane as indicated by a cross symbol. For example, the current 2402 may generate a clockwise magnetic field. As a result, the superposition of the counterclockwise magnetic field and the clockwise magnetic field at a boundary 2403 between the 2^{nd} turn and 3^{rd} turn is shown in FIG. 24A. For example, a maximum magnetic field may be located at boundary 2403.

FIG. 24B provides an example diagram of the H-field vector distribution of an NFC antenna using the innermost three turns 1912, according to some embodiments of the present disclosure. As shown in FIG. 24B, vectors of H-field on the observed plane are demonstrated when the NFC antenna is using the innermost two turns 1912. In some examples, the vectors of the H-field on the observed plane may be observed when the magnitude of the excitation current is maximum.

In some examples, current 2411 in the innermost 3 turns 1912 flow out of the plane as indicated by a dot symbol. For example, the current 2411 may generate a counterclockwise magnetic field. In some examples, current 2412 in remaining turns flow into the plane as indicated by a cross symbol. For example, the current 2412 may generate a clockwise magnetic field. As a result, superposition of counterclockwise magnetic field and the clockwise magnetic field at a boundary 2413 between 8th turn and 9th turn is shown in FIG. 24B. For example, a maximum magnetic field may be located at the boundary 2413.

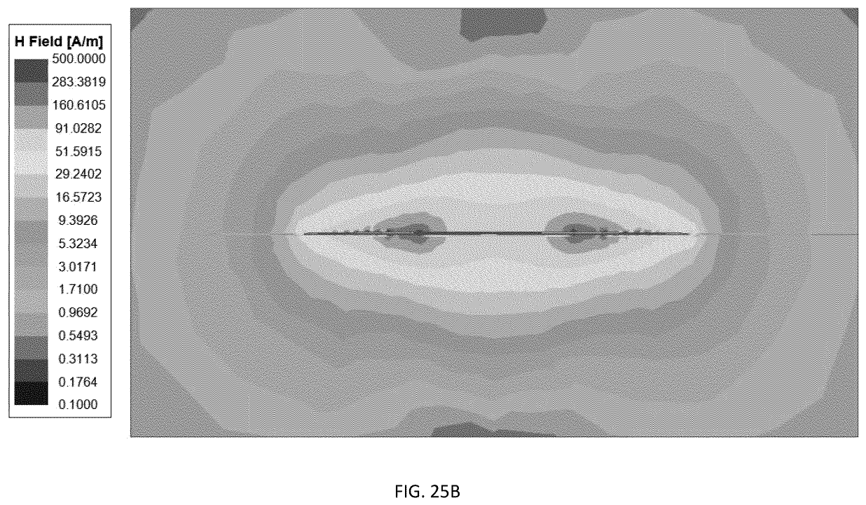

FIG. 25A provides an example diagram of a H-field magnitude distribution of an NFC antenna using the outermost two turns 1902, according to some embodiments of the present disclosure. FIG. 25B provides an example diagram of H-field magnitude distribution of an NFC antenna using the innermost three turns 1912, according to some embodiments of the present disclosure.

As shown in FIG. 25A and FIG. 25B, the H-field of an NFC antenna using the outermost two turns 1902 and the H-field of an NFC antenna using the innermost three turns 1912 have a similar magnetic field distribution. In some examples, the magnetic field at the center of the NFC antenna using the outermost two turns 1902 is much larger than magnetic field at a center of the NFC antenna using the innermost three turns 1912. In some examples, the magnetic field at the center of the NFC antenna using the outermost two turns 1902 has a wider magnetic field radiation area than the magnetic field at the center of the NFC antenna using the innermost three turns 1912.

### Experimental Setup

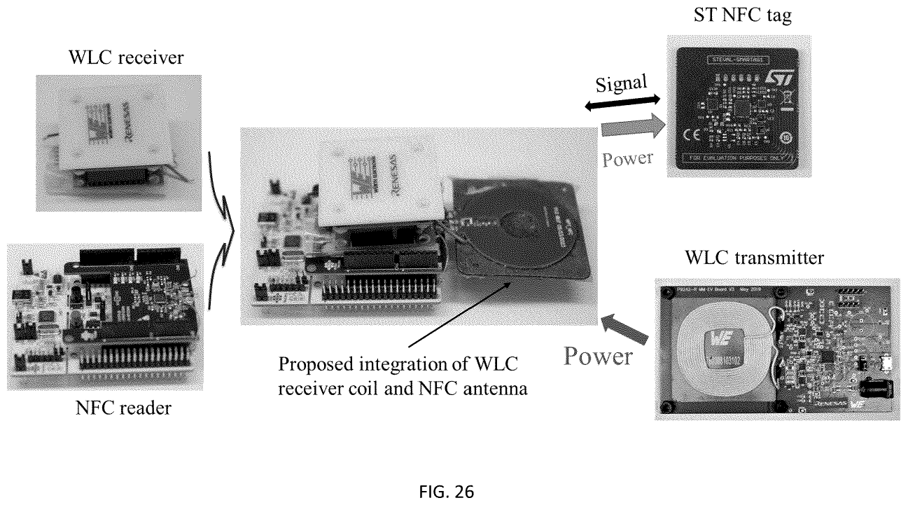

FIG. 26 provides an example diagram of an experimental setup, according to some embodiments of the present disclosure. For example, a WLC receiver may be a Renesas P9221 development kit, and an NFC reader may be a ST25R95 development kit. In some examples, a WLC transmitter may be a Renesas P9242 kit, and an NFC tag may be ST25DV64K. WLC and NFC electrical parameters are shown in TABLE I.

TABLE I
WLC and NFC electrical parameters

| Type | Terms | Value/model | Circuit parameter |
|---|---|---|---|
| WLC | WLC coil turn number | 11 turns | L_{WLC} = 8.25 uH |
| WLC | WLC receiver controller | Renesas | C_{R1} = 400 nF |
| | | P9221 | |
| WLC | WLC transmitter controller | Renesas | C_{R2} = 3.3 nF |
| | | P9242 | |
| NFC | NFC antenna turn number | 2/3 turns | L_{N1} = L_{N2} = 560 nH |
| NFC | NFC antenna inductance | 397 nH | C_{N1} = C_{N2} = 200 pF |
| NFC | NFC reader | ST25R95 | R_{N1} = R_{N2} = 330 Ω |
| NFC | NFC tag | ST25DV64K | C_{N3} = C_{N4} = 538 pF |

### WLC Module Experiment

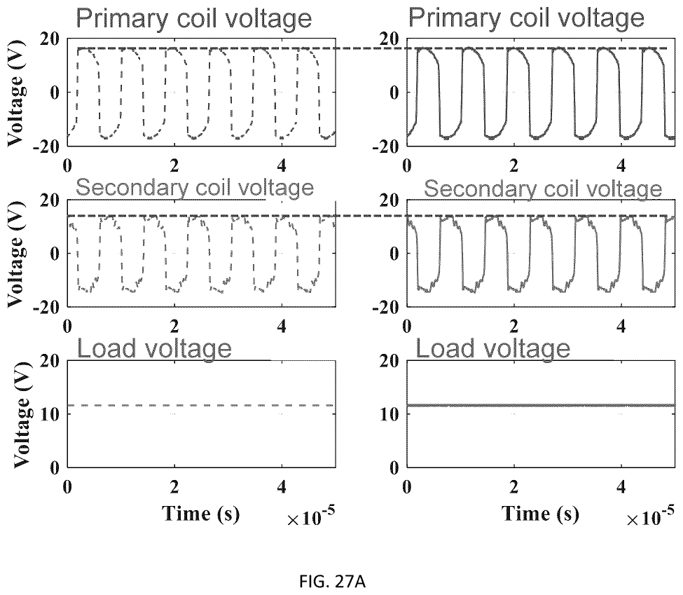

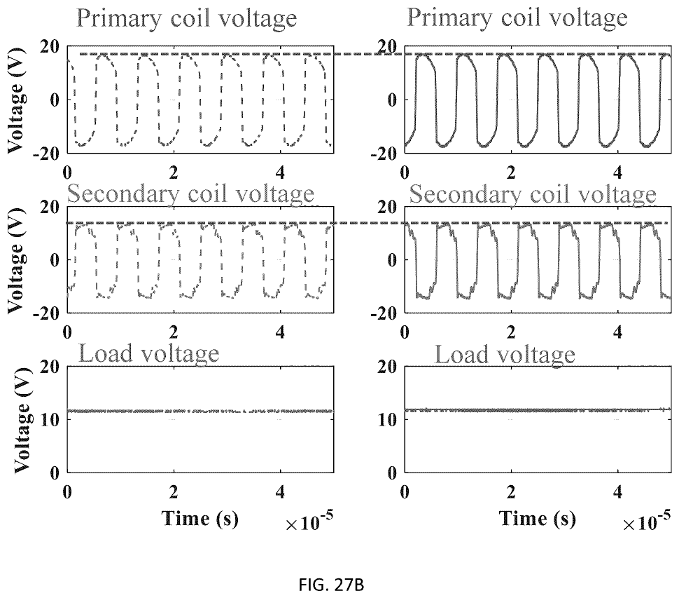

FIG. 27A provides example waveforms with and without the NFC circuit using the outermost two turns 1902, according to some embodiments of the present disclosure. FIG. 27B provides example waveforms with and without the NFC circuit using the innermost three turns 1912, according to some embodiments of the present disclosure.

In some examples, FIG. 27A and FIG. 27B demonstrate the impact of NFC circuit on WLC module operation by comparing the experiment of WLC module with and without NFC circuit. For example, the WLC coil is used for delivering a 15 W power to an LED array. The waveforms of primary coil voltage and secondary voltage are shown in FIG. 27A and FIG. 27B. For example, waveforms in dotted lines are detected without the NFC circuit and waveforms in solid lines are detected with the NFC circuit. The impact of NFC circuit on the WLC operation is neglectable based on FIG. 27A and FIG. 27B.

### NFC Module Experiment

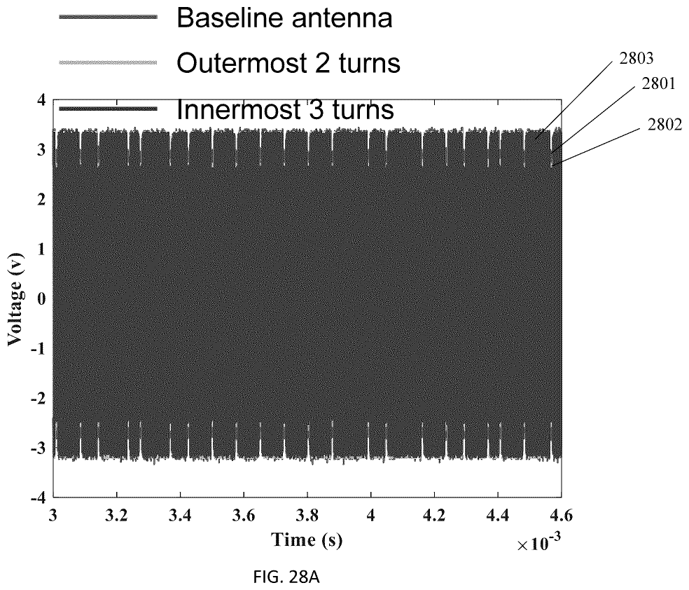

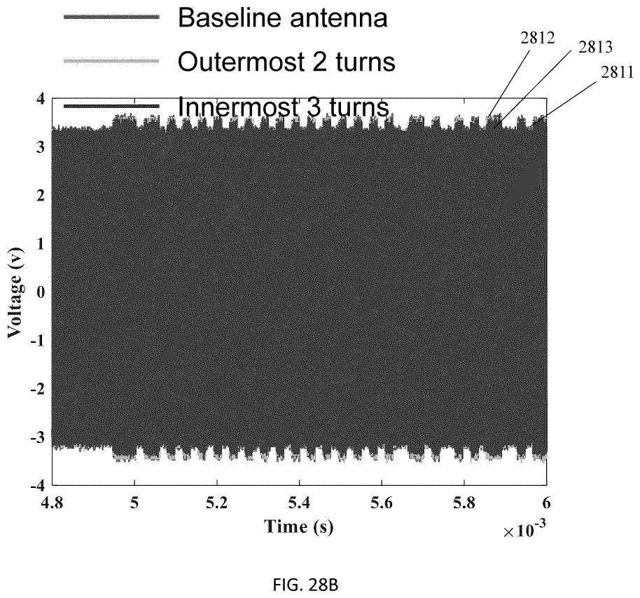

FIG. 28A provides example waveforms during a transmitting data phase, according to some embodiments of the present disclosure. FIG. 28B provides example waveforms during a data receiving phase, according to some embodiments of the present disclosure.

As shown in in FIG. 28A, waveforms of the NFC module experiment during the data transmitting phase are demonstrated. For example, waveform 2801 is generated during the data transmitting phase by a traditional NFC antenna (e.g., a baseline antenna) which has a same inductance as the NFC antenna. For example, waveform 2802 is generated during the data transmitting phase by an NFC antenna using the outermost two turns 1902. For example, waveform 2803 is generated during the data transmitting phase by an NFC antenna using the innermost three turns 1912.

As shown in FIG. 28B, waveforms of the NFC module experiment during the data receiving phase are demonstrated. For example, waveform 2811 is generated during the data receiving phase by a traditional NFC antenna (e.g., a baseline antenna) which has a same inductance as the NFC antenna. For example, waveform 2812 is generated during the data receiving phase by an NFC antenna using the outermost two turns 1902. For example, waveform 2813 is generated during the data receiving phase by an NFC antenna using the innermost three turns 1912.

As shown in FIG. 28A and FIG. 28B, difference between the waveforms (2801, 2802, and 2803) and difference between waveforms (2811, 2812, and 2813) are neglectable.

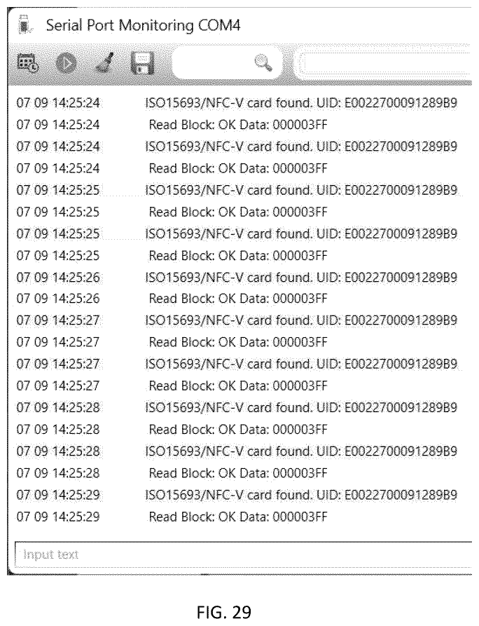

FIG. 29 provides example information received from a card, according to some embodiments of the present disclosure. For example, a serial port in a PC may identify the card correctly and read the data in the card, as shown in FIG. 29. For example, the example information received from the card may verify the effectiveness of the NFC antenna.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A device for multiplexing a wireless charging (WLC) coil for near-field communication (NFC), comprising:
the WLC coil with a first end, a second end, and a first contact point located between the first end and the second end;
a first terminal connected with the first end of the WLC coil;
a second terminal connected with the second end of the WLC coil; and
a third terminal connected with the first contact point of the WLC coil, wherein:
the first terminal of the WLC coil is configured to be a first WLC terminal;
the third terminal of the WLC coil is configured to be a first NFC terminal; and
the second terminal of the WLC coil is configured to be multiplexed as a second WLC terminal and a second NFC terminal.

2. The device according to claim 1, wherein:
the first WLC terminal and the second WLC terminal are connected to a battery to charge the battery wirelessly.

3. The device according to claim 1, wherein:
the first NFC terminal and the second NFC terminal are connected to an NFC IC for the NFC IC to communicate through NFC with a target device.

4. The device according to claim 1, wherein:
a number of turns of the WLC coil is in a range of 10-14 turns,
an inductance value of the WLC coil is in a range of 8-14 μH, and
a wireless charging frequency for the WLC coil is approximately 150 kHz.

5. The device according to claim 1, wherein:
an NFC antenna is formed between the first NFC terminal and the second NFC terminal.

6. The device according to claim 5, wherein a position of the first contact point depends on an inductance value of the NFC antenna.

7. The device according to claim 6, wherein:
a number of turns of the NFC antenna is in a range of 1-4 turns,
an inductance value of the NFC antenna is in a range of 0.2-4.0 μH, and
a communication frequency for the NFC antenna is approximately 13.56 MHz.

8. The device according to claim 1, wherein the WLC coil is formed in a circular shape or an oval shape.

9. A device for multiplexing a wireless charging (WLC) coil for near-field communication (NFC), comprising:
the WLC coil with a first end, a second end, a first contact point located between the first end and the second end, and a second contact point located between the first end and the second end;
a first terminal connected with the first end of the WLC coil;
a second terminal connected with the second end of the WLC coil;
a capacitor having a first plate of the capacitor connected with the first contact point of the WLC coil and a second plate of the capacitor connected with the second contact point of the WLC coil, wherein:
the first terminal of the WLC coil is configured to be multiplexed as a first WLC terminal and a first NFC terminal; and
the second terminal of the WLC coil is configured to be multiplexed as a second WLC terminal and a second NFC terminal.

10. The device according to claim 9, wherein:
the first WLC terminal and the second WLC terminal are connected to a battery to charge the battery wirelessly.

11. The device according to claim 9, wherein:
the first NFC terminal and the second NFC terminal are connected to an NFC IC for the NFC IC to communicate through NFC with a target device.

12. The device according to claim 9, wherein:
a capacitance value of the capacitor is in a range of 2-9 nF.

13. The device according to claim 9, wherein:
an NFC antenna is formed between the first NFC terminal and the second NFC terminal.

14. The device according to claim 13, wherein:
a position of the first contact point and a position of the second contact point depend on an inductance value of the NFC antenna.

15. The device according to claim 9, wherein:
the WLC coil is formed in one of a circular shape and an oval shape.
